(19) United States
(12) Patent Application Publication
(10) Pub. No.: US 2024/0190732 A1
(43) Pub. Date: Jun. 13, 2024

(54) DRY POWDER MIXTURE FOR TOTAL PHOSPHORUS REMOVAL WITHIN WATER AND WASTEWATER TREATMENT

(71) Applicant: Garrison Minerals, LLC, Wheat Ridge, CO (US)

(72) Inventors: Mac McCreless, Wheat Ridge, CO (US); Kevin Marshall, Wheat Ridge, CO (US); Jacob Joachim, Wheat Ridge, CO (US); Hailee Wright, Wheat Ridge, CO (US)

(21) Appl. No.: 18/286,180

(22) PCT Filed: Apr. 11, 2022
(86) PCT No.: PCT/US2022/024212

§ 371 Date: Oct. 9, 2023

Related U.S. Application Data
(60) Provisional application No. 63/173,035, filed on Apr. 9, 2021.

(51) Int. Cl. C02F 1/52; C02F 101/10

(52) U.S. Cl. CPC C02F 1/5245; C02F 2101/105; C02F 2305/00

(57) ABSTRACT

The present invention describes a powder mixture and delivery method for the treatment of wastewater and water streams for the removal of phosphorus-containing compounds. The solid mixture is comprised of an aluminum-based coagulant mixed with a magnesium-containing compound and, optionally, additional compounds to aid in the control of pH, alkalinity, sludge production, settling rate, and other factors. This solid mixture is delivered to a wastewater stream or unit process where the aluminum-based coagulant works to react with, flocculate, and/or coagulate phosphorus compounds prior to their removal.

### CROSS REFERENCE TO RELATED APPLICATIONS

This International PCT application claims the benefit of and priority to U.S. Provisional Application No. 63/173,035 filed Apr. 9, 2021, the specification, claims and drawings of which are incorporated herein by reference in their entirety.

### FIELD OF INVENTION

The present disclosure generally relates to the methods and compositions for the treatment of water, and in particular wastewater. Specifically, the present invention includes systems. methods and compositions for the removal of phosphorus and phosphorus-containing compounds from water, and preferably wastewater. In one preferred embodiment, this invention includes composition of a dry powder mixture having similar properties to drug delivery kinetics, where kinetics of the flocculation of phosphorus and its compounds are facilitated by control of the pH over time using particle size and dissolution rate over time.

### BACKGROUND

Municipal and industrial effluent wastewater must be sufficiently treated before returning to natural waterways or supplied as drinking water. Phosphorus is known to be one of the leading causes of eutrophication of natural waterways and water bodies. Sources of phosphorus include discharge streams from both water and wastewater treatment plants, industrial wastewater, and agricultural runoff, among others. Prevention of phosphorus from entering natural water bodies requires some sort of water/wastewater treatment process, which may include mechanical separation, biological treatment, and/or chemical treatment. One of the leading methods for phosphorus removal is chemical precipitation, wherein the standard practice typically employs liquid aluminum sulfate (alum), ferric chloride, ferric sulfate polyaluminum chlorides (PACs), aluminum chlorohydrates, sodium aluminate, or calcium hydroxide, and others.

The chemical dosing of such compounds for phosphorus removal implies downstream disturbances in process stream properties such as pH, sludge mass, alkalinity, and turbidity. Therefore, the majority of chemical precipitation methods require an additional unit operation or dosing chemical agents that establish a control over such parameters. In doing so, proper functionality of other treatment processes, such as aerobic and anaerobic digestion, ensures improved efficiency. Magnesium and calcium compounds such as oxides, hydroxides, and carbonates are often used to offset the negative effects of the chemical agent used for phosphorus removal. There are no known methods or products that simultaneously address both phosphorus removal and control over process stream conditions.

Moreover, all state-of-the-art compositions of matter in use for wastewater and water treatment, or state-of-the-art as described in the literature, use solution-based compounds. The use of solution-based aluminum coagulants prohibits the mixing of a magnesium-, calcium-, or sodium-based compound as the mixture would react and render the formulation ineffective. Thus, the state-of-the-art describes at least two steps and at least two separate formulations of raw material reservoirs that are used for phosphorus removal and subsequent modification of properties such as pH and alkalinity, and often dosed into a wastewater or water treatment facility in two separate steps.

The use of dry chemical coagulants for phosphorus removal has been precluded for economic reasons as solid alum, which is generally more expensive than liquid alum. Consequently, the mixing and preparation of two or more solid chemical compounds for simultaneous phosphorus removal and stream property control has not been previously considered. As such, there is a long-felt need within the industry for a dry-powder composition that simultaneously addresses both phosphorus removal and control over process stream conditions.

### SUMMARY OF THE INVENTION

The present invention provides for phosphorus removal, which includes dissolved and particulate substances including phosphates. The invention further establishes baseline control of other stream parameters such as pH, alkalinity, turbidity, and produced sludge mass and volume in order to meet specifications set forth by state and federal rules and regulations.

Particularly, the purpose of this invention is to describe a powder formulation that can aid in the chemical removal of phosphorus while maintaining adequate alkalinity and pH range for extended periods of time during which phosphorus is being coagulated and precipitated into a sludge byproduct that can be easily removed from the water or wastewater stream.

The present invention disclosure describes a dry powder mixture of at least two compounds: an aluminum-based coagulant and a magnesium-based compound for pH and alkalinity control. Additional compounds may be added in alternative embodiments to enhance the properties of the dry powder mixture, especially if pelletized, such as shelf-life, ease of pelletization, ease of dissolution or pellet attrition after dosing, and/or other physical properties. In still further embodiments, additional compounds may be added to enhance the performance of the composition of the invention such as additional time-based control over alkalinity, pH, phosphorus removal, reaction rates, settling rates, and properties of the resulting sludge.

In one embodiment of the invention, a dry ferric chloride has been contemplated as a substitute for an aluminum-based coagulant. In line with the invention, the dry ferric chloride may be mixed with a hydroxide, and preferably a magnesium oxide as a feed mixture for phosphorus removal and for maintaining alkalinity. Only a dry powder mixture is applicable, as ferric chloride and hydroxides react violently in the presence of water.

The use of dry powder mixtures prevents the reaction of an aluminum-based coagulant with a magnesium-based compound, allowing the two compounds to be mixed together in a single reservoir tank or vessel and dosed to a wastewater or water treatment unit operation in a single step. The method of delivery can be any standard apparatus to control the amount of solids be conveyed from a tank or vessel to another region such as a Venturi eductor, auger, pneumatic conveyor, or other mechanical conveyance. Similarly, the dry powder mixture may be pelletized or tableted to ensure ease of control of conveyance from a storage tank to the treatment site. The rates of dissolution of pellets versus powders can be tuned. However, it is known that aluminum sulfate dissolves rapidly in water and therefore would cause pellets to break down quickly without additional agitation or mechanical attrition.

Beyond the two base compounds comprising a phosphorus-removing coagulant and a base for re-establishing pH and alkalinity to desired levels, other compounds may be added for a wide range of purposes. For example, carbonates such as sodium, magnesium, and calcium carbonate would add to the effectiveness of re-establishing alkalinity. Flocculation and/or coagulation polymers would affect the precipitation and settling efficiencies. Magnesium stearate, bentonite, or an organic compound, such as starch or glucose, may be added as a lubricant and/or binder for pelletization.

Any of the above and others would increase shelf-life of the product, especially in conditions with high atmospheric humidity, which could be absorbed by the powder or pellets and leading to reaction of the phosphorus-removing coagulant and magnesium-containing compound. Acids such as citric, hydrochloric, and other acids that are able to be produced as solids may aid in reducing the pH if the phosphorus-removing compound does not reduce the pH to the desired operational range of 5.5-6.5.

Therefore, the present invention is an improvement over the state of the art because the invention 1) simplifies dosing of an aluminum-based coagulant and a hydroxide compound into a single step where, as a dry powder mixture, the two compounds do not react; 2) allows for unregulated control of the pH to be maintained within the ideal range of 5.0-7.0 for the best effectiveness of coagulation of phosphorus with an aluminum-based compound for a time sufficient to coagulate and precipitate a majority of the phosphorus and phosphorus-containing compounds; 3) maintains and/or re-establishes the required level of alkalinity for other wastewater and water treatment steps; and 4) eliminates the need to store hazardous materials onsite at a water/wastewater treatment facility.

### DETAILED DESCRIPTION OF THE INVENTION

It is to be understood that this summary, description, and articulated embodiments of the invention disclosed are not limited to the particular structures, process steps, or materials disclosed herein, but are extended to the equivalents thereof as would be recovered by those ordinarily skilled in the relevant arts. It should also be understood that terminology employed herein is used for the purpose of describing particular embodiments only and is not intended to be limiting.

There are a variety of metal salts that wastewater treatment plants may choose from for chemical precipitation of phosphorus. The possibility of combining these chemical precipitants with another compound to provide pH and alkalinity control, as well as any number of additional compounds, is enumerated above. For the purposes of illustrating the effectiveness of the invention, aluminum sulfate and magnesium-containing compounds are detailed here.

Alum can be an effective phosphate (PO₄³⁻) binding agent due to the trivalent cation nature of aluminum (Al³⁺). There are three main reactions that occur during alum addition to wastewater reaction with PO₄³⁻ to form AlPO₄ precipitate (source of phosphorus removal), reaction with carbonate ions to form Al(OH)₃ and CO₂ (source of alkalinity consumption), and alum hydrolysis to form more Al(OH)₃ and H₂SO₄ (source of pH depression).

Phosphorus Reaction:

Al₂(SO₄)₃₍ₛ₎+2PO₄³⁻_{(aq)}<=>2AlPO₄₍ₛ₎+3SO₄²⁻_{(aq}

Alkalinity Reaction:

Al₂(SO₄)₃₍ₛ₎+6HCO₃⁻_{(aq)}=>2Al(OH)₃₍ₛ₎+3SO₄²⁻_{(aq)}+6CO_{2(g)}

Hydrolysis Reaction:

Al₂(SO₄)₃₍ₛ₎+6H₂O₍ₗ₎<=>2Al(OH)₃₍ₛ₎+6H⁺+3SO₄²⁻_{(aq)}

The AlPO₄ precipitate is minimized between a pH of 5.5-6.5, representing the desired range of operation. If the influent stream has a high alkalinity (e.g. 4,000 meq/L CaCO₃) and a high pH (e.g. <8), the buffering capacity will resist pH depression which could hinder precipitation of AlPO₄. Therefore, for high alkalinity streams, alum typically must be dosed 2-4× the stoichiometric amount of Al₂(SO₄)₃ to PO₄³⁻. This comes as a cost since a significant amount of alkalinity can be consumed to reach the minimum solubility pH window of AlPO₄. If the influent stream has low alkalinity (e.g. 100 meq/L CaCO₃), the pH could drop significantly below 5.5 and the majority of AlPO₄ would remain in solution. In both cases, alkalinity and/or pH control unit operations will need to be performed to ensure effective total phosphorus removal.

As described herein, the present invention describes novel methods, systems, and composition for the removal of phosphorous continuing compounds from water, and preferably waste-water. In one preferred embodiment, the invention includes a system for treating water, and in particular a quantity of water continuing phosphorus, generally in the form of phosphorous containing compounds, including, but not limited to organic compounds and phosphates, such as orthophosphates and polyphosphates and the like. In a preferred embodiment, the system of the invention further include a dry powder mixture containing at least a phosphorus coagulant and a magnesium-based compound that can be contacted with the water to be treated causing the precipitation of phosphorus in the treated water.

In a preferred embodiment, the dry powder composition of the invention causes the flocculation of phosphorus containing compounds. As used herein, “flocculation” or “floc” refers to the process by which colloids come out of suspension in the form of floc or flakes. For example, flocculation refers to the process by which fine particulates are caused to clump together into floc, which can float to the top or bottom of a liquid, and preferably wastewater. As used herein, “wastewater” means water having impurities and/or contaminants therein. In some embodiments, wastewater includes: sanitary wastewater, industrial (or process) wastewater, storm water (e.g., run-off) and/or combinations thereof. As some non-limiting examples, wastewater treated in accordance with one or more embodiments of the instant disclosure can include the following contaminants/impurities: viruses, bacteria, protozoa, algae, oil, grease, pharmaceuticals, ammonia, phosphorous, heavy metals (e.g. arsenic, mercury, chromium), and others. As used herein, “treating” water, means removing one or more impurities and/or contaminants, and in particular phosphorus-containing compounds, from the water to be treated.

The phosphorus coagulant of the invention includes an aluminum-based phosphorus coagulant. In a preferred embodiment, the aluminum-based phosphorus coagulant may include a dry powder of aluminum sulfate, aluminum chloride, aluminate, or a combination of the same. In this preferred embodiment, the aluminum-based phosphorus coagulant has a particle size range less than or equal to 1 millimeter. The magnesium-based compound of the invention may include a dry powder of magnesium hydroxide, magnesium oxide, magnesium carbonate, brucite, or a combination of the same. In this preferred embodiment, the magnesium-based compound of the invention has a particle size range less than or equal to 10 millimeter. In a preferred embodiment, the dry powder of the invention may contain more aluminum-based phosphorus coagulant than aluminum-based phosphorus coagulant. Notably, as shown in Table 1 below, in a preferred embodiment the Wt % composition (aluminum coagulant/magnesium-based compound (Alum/Mg) may be between approximately 60-90%. As further noted in Table 1, in one example, removal of PO₄ from a quantity of water to be treated with the various embodiments of the compositions of the invention may be between approximately 85% to greater than 99%.

In an alternative embodiment, the phosphorus coagulant of the invention may include an iron-based phosphorus coagulant. In a preferred embodiment, the iron-based phosphorus coagulant of the invention may include dry ferric chloride mixed with a magnesium-based compound such as magnesium hydroxide, magnesium oxide, magnesium carbonate, brucite, or a combination of the same.

The dry powder of the invention may further include additional solids, preferably in the form of a powder that a compound configured to increase the shelf-life of the dry powder composition of the invention. In one preferred embodiment, the additional composition may include an acidifying compound, and preferably a solid form citric acid, hydrochloric acid, or a combination of the same. In another preferred embodiment, the additional composition may include one or more binding agents and/or lubricants for pelletization of the dry powder composition, such as magnesium stearate, bentonite, organic compounds such as starch, glucose, or a combination of the same. In another preferred embodiment, the additional composition may include one or more alkaline compounds, a carbonate compound such as sodium carbonate, magnesium carbonate, calcium carbonate, or a combination of the same.

In the present invention disclosure, the magnesium-based compound, preferably a magnesium oxide or magnesium hydroxide, has a select particle size range and/or chemical reactivity such that the rate of dissolution allows for in-situ and automatic control of the pH to remain within the preferred range of 5-7, 5.5-6.5 or 6 for at least 30 minutes and preferably around 60 minutes, as dictated by average settling times of the phosphorus-containing compounds. The method also provides for ensuring alkalinity is sufficiently high for other wastewater or water treatment steps such as anaerobic or aerobic digestion. Therefore, a hydroxide material is added to buffer the pH and maintain it at the ideal conditions. Dosing is usually performed with feedback control using empirical parameters.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “any combination thereof” as used herein refers to all permutations and combinations of the listed items preceding the term. For example, “A, B, C, or any combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

The invention now being generally described will be more readily understood by reference to the following examples, which are included merely for the purposes of illustration of certain aspects of the embodiments of the present invention. The examples are not intended to limit the invention, as one of skill in the art would recognize from the above teachings and the following examples that other techniques and methods can satisfy the claims and can be employed without departing from the scope of the claimed invention.

### EXAMPLES

The tests conducted by the present inventors below are reported using 4× the required stoichiometric amount of aluminum for phosphate removal.

Example 1: Mixing dry Mg(OH)₂ with dry aluminum sulfate and adding to 1 liter of sample. Initial total P=12.1 ppm. Final pH=7.14; final total P=0.11 ppm

Example 2: Making a 50% slurry by adding the same weight as Example 1 in water and then adding to 1 liter of sample. Initial total P=11.4 ppm. Final pH=7.71; final total P=2.86 ppm.

Example 3: Added the slurry from Example 2 to 1 liter of sample. Initial total P=13.5 ppm. Dosed an additional 0.04 g Mg(OH)2 for pH control. Final pH=6.62; final total P=1.75 ppm.

Example 4: Adding the reagents aluminum sulfate and magnesium hydroxide as a dry powder mixture had the best results with an ending phosphate concentration of 0.11 ppm, showing an effective removal rate of 99% (beginning concentration was 12.1 ppm PO₄).

The tests below were using wastewater obtained from Greeley, Colorado's municipal wastewater treatment facility. The primary testing stream was the centrate. While these tests were performed on the centrate stream, this does not preclude use of this invention on other wastewater or water treatment streams and unit operations.

Example 7: Samples were diluted with deionized water in a 1:200 ratio. Two-times the stoichiometric requirement of aluminum sulfate was used with an equal mass ratio of brucite UM-10. Trial time was 60 minutes. Each solution was filtered using qualitative filter paper to remove the precipitated/coagulated/flocculated phosphorus. A control was conducted to ensure total phosphorus was not decreasing upon filtration alone. Results of Trials 6 and 7 are represented in Table 1.

Example 8: Brucite, the mineral form of magnesium hydroxide, appears to work better compared to hydrated magnesium oxide because the pH rises at a slower rate. It is known that the phosphorus precipitation reaction with aluminum sulfate works best between a pH of 5-6.5. Therefore, enough time for the precipitation reaction to occur during this pH range is needed. When hydrated MgO is used instead of brucite, the pH rises too quickly and there is not enough time for the alum/phosphorus reaction to go to completion. Other physio-chemical properties of the magnesium hydroxide compound need to be considered such as reactivity, particle size, and impurities.

Example 9: In some experiments if alum is added by itself, the pH gets depressed significantly (<3 pH) and does not pick back up and no phosphorus is removed. Precipitated Al(PO₄) is least soluble around a pH of 5.5-6.5, hence why using a hydrated Mg/alum mixture may be included as a preferred embodiment, because it can depress the pH and slowly raise it back up to allow Al(PO₄) to drop out of solution. Currently, many wastewater plants have a unit operation for adding alum and a separate unit operation to add lime later in the process to raise the pH (and add a source of alkalinity). The solubility constant (Ksp) of lime is significantly higher than the Ksp of Mg, which means there is a potential to overdose when using lime which could raise the pH higher than it should and cause Al(PO₄) to go back into solution. Magnesium hydroxide cannot be overdosed—as the highest pH it achieves is around 8.5. Even at a considerably high pH, the majority of Al(PO₄) remains as a precipitate.

### Tables

TABLE 1
Select trials of dry powder mixtures or pellets with aluminum sulfate and a magnesium-
containing compound.

| | | Amount | | Amount of | Amount | | Wt % | | | | | Total |
|---|---|---|---|---|---|---|---|---|---|---|---|---|
| | | of | | Mg- | of | Total | Compo- | Initial | Final | Initial | Final | PO₄ |
| Trial | Sample | Sample | Form of | compound | Al₂(SO₄)₃ | Weight | sition | CaCO₃ | CaCO₃ | Total PO₄ | PO₄ | Removal |
| # | Type | (mL) | Mg | Added (g) | Added (g) | (g) | (Alum/Mag) | (meq/L) | (meq/L) | (mg/L) | (mg/L) | (%) |
| 1 | Centrate | 1000 | MgO | 0.69 | 2.07 | 2.76 | 75.00% | 340 | 1,105 | 590.00 | 7.25 | 98.77% |
| 2 | Dewatering | 250 | Hydrated | 0.245 | 0.735 | 0.98 | 75.00% | 4,095 | 3,903 | 811 | 62.20 | 92.33% |
| | Centrate | | MgO | | | | | | | | | |
| 3 | Dewatering | 244 | Hydrated | 0.2375 | 0.7125 | 0.95 | 71.25% | 4,095 | 4,254 | 811 | 38.70 | 95.23% |
| | Centrate | | MgO | | | | | | | | | |
| 4 | Bio Clarifier | 500 | MgO | 0.011 | 0.031 | 0.042 | 73.81% | 127 | 123 | 6.85 | 0.40 | 94.16% |
| 5 | Splitter Box | 1000 | MgO | 0.029 | 0.085 | 0.114 | 74.56% | 255 | 295 | 7.76 | 1.15 | 85.19% |
| 6 | Dewatering | 200 | Brucite | 1.654 | 2.504 | 4.158 | 60.22% | 4,054 | 5,305 | 1,088 | 3.44 | 99.68% |
| | Centrate | | | | | | | | | | | |
| 7 | Dewatering | 200 | Brucite | 1.666 | 2.506 | 4.172 | 60.07% | 4,054 | 13,512 | 1,088 | 4.61 | 99.58% |
| | Centrate | | | | | | | | | | | |
| 8 | Dewatering | 200 | Hydrated | 1.662 | 2.5 | 4.162 | 60.07% | 4,054 | 7,757 | 1,088 | 6.03 | 99.45% |
| | Centrate | | MgO | | | | | | | | | |
| 9 | De watering | 200 | Hydrated | 1.075 | 2.5 | 3.575 | 69.93% | 4,054 | 4,254 | 1,088 | 6.39 | 99.41% |
| | Centrate | | MgO | | | | | | | | | |
| 10 | Dewatering | 200 | Hydrated | 0.278 | 2.504 | 2.782 | 90.01% | 4,054 | 2,077 | 1,088 | 7.38 | 99.32% |
| | Centrate | | MgO | | | | | | | | | |
| 11 | Dewatering | 200 | Hydrated | 1.074 | 2.502 | 3.576 | 69.97% | 4,054 | 8,282 | 1,088 | 6.69 | 99.39% |
| | Centrate | | MgO | | | | | | | | | |

1. A system for treating water comprising:
a quantity of phosphorus containing water to be treated;
a dry powder containing a mixture of:
a phosphorus coagulant;
a magnesium-based compound; and
wherein said dry powder composition causes the precipitation of phosphorus in the treated water.

2. The system of claim 1, wherein said phosphorus coagulant comprises an aluminum-based phosphorus coagulant, or an iron-based phosphorus coagulant.

3. The system of claim 2, wherein said iron-based phosphorus coagulant comprises dry ferric chloride.

4. The system of claim 2, wherein said aluminum-based phosphorus coagulant is selected from the group consisting of: aluminum sulfate, aluminum chloride, aluminate, or a combination of the same.

5. The system of claim 2, wherein said aluminum-based phosphorus coagulant has a particle size range less than or equal to 1 millimeter.

6. The system of claim 1 wherein said magnesium-based compound is selected from the group consisting of: magnesium hydroxide, magnesium oxide, magnesium carbonate, brucite, or a combination of the same.

7. The system of claim 1, wherein said magnesium-based compound has a particle size range less than or equal to 10 millimeter.

8. (canceled)

9. The system of claim 1, and further comprising an acidifying compound.

10. The system of claim 9, wherein said acidifying compound is selected from the group consisting of: an acid in the form of a solid, citric acid, hydrochloric acid, or a combination of the same.

11. The system of claim 1, and further comprising a binding agent or lubricant for pelletization of said composition.

12. (canceled)

13. The system of claim 1, and further comprising an alkaline compound.

14. The system of claim 13, wherein said alkaline compound is selected from the group consisting of: a carbonate, sodium carbonate, magnesium carbonate, calcium carbonate, or a combination of the same.

15-16. (canceled)

17. A composition for treating water comprising:
a dry powder containing a mixture of:
an aluminum-based phosphorus coagulant;
a magnesium-based compound; and
wherein said dry powder composition causes the precipitation of phosphorus.

18-22. (canceled)

23. The composition of claim 17, and further comprising an acidifying compound.

24. (canceled)

25. The composition of claim 17, and further comprising a binding agent or lubricant for pelletization of said composition.

26. (canceled)

27. The composition of claim 17, and further comprising an alkaline compound.

28-30. (canceled)

31. A dry powder composition for the precipitation of phosphorus from water comprising:
a dry powder containing a mixture of:
an iron-based phosphorus coagulant;
a magnesium-based compound; and
wherein said dry powder composition causes the precipitation of phosphorus.

32-35. (canceled)

36. The composition of claim 31, and further comprising an acidifying compound.

37. (canceled)

38. The composition of claim 31, and further comprising a binding agent and/or lubricant for pelletization of said composition.

39. (canceled)

40. The composition of claim 31, and further comprising an alkaline compound.

41-62. (canceled)
